(19) United States
(12) Patent Application Publication
(10) Pub. No.: US 2004/0127648 A1
(43) Pub. Date: Jul. 1, 2004

(54) Sorbent and method for the separation of plasmid DNA

(75) Inventors: Luc Guerrier, Versailles (FR); Egisto Boschetti, Croissy sur Seine (FR)

Correspondence Address: FOLEY AND LARDNER, SUITE 500, 3000 K STREET NW, WASHINGTON, DC, 20007, US

(73) Assignee: Ciphergen Biosystems, Inc., Fremont, CA

(21) Appl. No.: 10/334,135

(22) Filed: Dec. 31, 2002

(51) Int. Cl. C08L 33/06

(52) U.S. Cl. 525/227

(57) ABSTRACT

A polymer that is useful for separating plasmid DNA from cell lysates can be dispersed throughout the pores of a porous matrix, forming a chromatographic sorbent. Illustrative of such a polymer is one that comports with the formula:

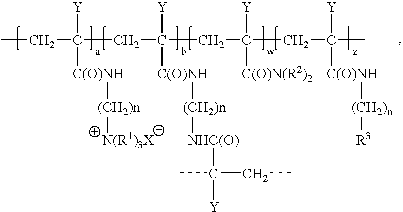

where R¹ is C₁₋₆ alkyl; each R² is independently selected from the group consisting of H and C₁₋₆ alkyl, optionally substituted with 1 to 3 OH groups; R³ is selected from H, C₁₋₁₄ alkyl, and (C₁₋₁₄ alkyl)aryl; each n is independently an integer from 1 to 6; a is at least 1; b is at least 1; w is an integer from 0 to 10; and z is at least 1. X is an anion; each Y is independently selected from the group consisting of H, C₁₋₆ alkyl, and a linear homopolymer comprised of monomers, each of them substituted with pendant amines, provided that at least one Y is the linear homopolymer; and “-----” represents the remainder of the polymer.

### BACKGROUND OF THE INVENTION

The present invention relates to mixed mode polymers and to processes of making and using them in the context of separation science.

The advent of recombinant DNA ushered in an increasing need to develop more exacting methods of purifying DNA, such as that used for pharmaceutical grade DNA. Known techniques for separating different forms of nucleic acids in or recovery of plasmid DNA from cellular lysates typically rely upon density gradient centrifugation or extraction with toxic organic solvents. However, centrifugation is not practical or economic for large-scale purification, while the use of toxic organic solvents presents numerous problems in pharmaceutical applications.

Other methods of separating and purifying plasmid DNA employ classical anion exchange resins. In these cases, RNA is typically present in substantial quantities in plasmid DNA fractions. Consequently, RNAse is added to digest the RNA before chromatographic separation, thereby greatly increasing the likelihood that the purified plasmid DNA will be contaminated with RNAse. The presence of RNAse in the purified product can exert hazardous effects on the subsequent use of the purified DNA.

U.S. Pat. No. 5,561,064 discloses a method for the production of pharmaceutical plasmid DNA. A cell lysate containing plasmid DNA is ultimately subjected to multiple differential PEG (polyethylene glycol) precipitation and chromatography steps.

U.S. Pat. No. 5,910,584 describes the use of various calcium phosphate particles to adsorb RNA from a cell lysate.

U.S. Pat. No. 5,843,312 discloses a sorbent for the separation of DNA from RNA. The sorbent is based upon metal oxides that are modified with a silanization reagent. However, the silanization reagent is susceptible to polymerization and its use typically necessitates the use of an inert atmosphere.

Finally, PCT application WO 96/36706 discloses a method of separation and purifying plasmid DNA. The method includes subjecting a clarified lysate to multiple filtration steps, optional treatment with RNAse, and reverse phase chromatography.

Despite the advances represented by the number of chromatographic sorbents designed to purify plasmid DNA, there remains a continued need to develop sorbents for the purification of DNA, fully dispensing with the use of toxic solvents, RNAse, and cumbersome equipment. Additionally, it would be desirable to have the ability to exert a high degree of control over the chemical properties of such sorbents, thereby allowing more precise separation of different forms of plasmid DNA.

### SUMMARY OF THE INVENTION

The present invention satisfies these needs and others by providing an economical and highly tailorable chromatographic sorbent, which is especially useful for separating and purifying such DNA. Separation of plasmid DNA can be achieved in a single step and avoids the use of potential contaminants such as RNAse. Additionally, methods of making the sorbent require only readily available and air-stable reagents.

One embodiment of the present invention is a polymer comprised of a crosslinked copolymer covalently attached to a linear homopolymer. The crosslinked copolymer comprises acrylic monomers substituted with quaternary ammonium moieties, hydrophobic acrylic monomers, and acrylic polyfunctional crosslinking monomers. The linear homopolymer comprises monomers, each of which is substituted with a pendant amine group. In a preferred embodiment, the crosslinked copolymer further comprises acrylic spacer monomers.

The pendant amine groups on the linear homopolymer include primary, secondary, and tertiary amines, and preferably are secondary or tertiary amines. Exemplary homopolymers in this context include poly-dimethylaminopropyl-methacrylamide, poly-diethylaminoethyl-methacrylamide, polyallylamine, polyvinylamine, polyethyleneimine, chitosan, and polylysine.

The hydrophobic acrylic monomers of the crosslinked copolymer preferably are those selected from monomers comprising aliphatic groups, aromatic groups, or both. Preferred monomers include tert-butyl-acrylamide, n-butyl-acrylamide, n-isopropyl-acrylamide, tert-octyl-acrylamide, methyl-undecyl-acrylamide, octadecyl-acrylamide, phenyl-acrylamide, acrylamido-phenylalanine ethyl ester, and mixtures of these monomers.

In a preferred embodiment, the polymer of this invention conforms to the following general chemical formula:

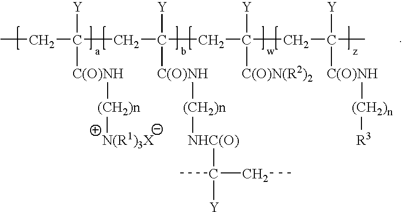

In the formula above, each R¹ is C₁₋₆ alkyl; each R² is independently selected from the group consisting of H and C₁₋₆ alkyl optionally substituted with 1 to 3 OH groups; and R³ is selected from H, C₁₋₁₄ alkyl, and (C₁₋₁₄ alkyl)aryl.

Additionally, each n is independently an integer from 1 to 6. The formula is meant to convey that the polymer comprises monomers represented by subscripts “a”, “b”, “z”, optionally including “w,” in any order and in relative amounts described more fully below. Thus, the polymer comprises at least one acrylic monomer bearing a quaternary ammonium group, corresponding to a being at least 1. Similarly, b and z are each at least 1 such that the polymer comprises at least one acrylic crosslinking monomer and hydrophobic acrylic monomer, respectively. The polymer may comprise an acrylic spacer monomer where w is an integer from 0 to 10.

The quaternary ammonium moiety of the polymer is charge-balanced with an anion X. Each Y is independently selected from the group consisting of H, C₁₋₆ alkyl, and the linear homopolymer. However, at least one Y in the formula above must represent the linear homopolymer. Finally, the dashed lines (i.e., “-----”) represent the remainder of the polymer, attached through the cross-linking monomer and comprised of monomers represented by subscripts “a”, “b”, “z”, optionally including “w.”

Another embodiment of the present invention is a chromatographic sorbent comprising the polymer of this invention and a porous matrix. The polymer is dispersed within the pores of the porous matrix. The porous matrix is selected from materials such as metal oxides, ceramics, natural polymers, synthetic polymers. The porous matrix can also be a mixture of these materials.

In a preferred embodiment, the porous matrix is a metal oxide selected from silica, alumina, hafnia, titania, and zirconia. Alternatively, the porous matrix is a natural polymer, preferably a polysaccharide selected from agarose, dextran, cellulose, chitin and derivatives thereof, and alginic acid. The porous matrix may also be a synthetic polymer selected from polyacrylamides, polyacrylates, polyvinyl polymers, polystyrenes, polyurethanes, polyamides, and polyfluorinated derivatives and copolymers of these polymers.

Preferably, the porous matrix exists in the form of beads. The sizes of the beads range from about 10 microns to about 500 microns. The beads may also be characterized in terms of their density, which can vary from about 1 g/cm³ to about 10 g/cm³.

Still another embodiment of the present invention is a method for the separation of DNA plasmids on the polymer as described above. In this method, a lysate comprising DNA plasmids is loaded onto the polymer, causing the plasmids to adsorb to the polymer. An equilibration buffer is then applied as a wash to the polymer with bound DNA plasmids in order to remove any non-plasmid material. Finally, the DNA plasmids are desorbed from the polymer by applying an eluant comprising a salt solution to the polymer.

The method is preferably performed in a chromatography column, but is applicable in other contexts, such as batch separations where the polymer is suspended in a solution. Alternatively, the separation may be achieved where the polymer is fixed on the surfaces of reaction vessels, microtiter plates, pipette tips, agitator rods, or even test strips.

Preferably, the lysate is a clarified lysate. More preferably, the lysate comprises at least two different forms of DNA plasmids. In this context, the method further comprises the separation of the different forms of plasmids.

Yet another embodiment of the invention is a method for the separation of DNA plasmids on the chromatographic sorbent as described above. In this method, a lysate comprising DNA plasmids is loaded onto the sorbent, causing the plasmids to adsorb to the polymer. An equilibration buffer is then applied as a wash to the polymer with bound DNA plasmids in order to remove any non-plasmid material. Finally, the DNA plasmids are desorbed from the polymer by applying an eluant comprising a salt solution to the polymer.

Preferably, the porous matrix of the sorbent is a metal oxide. The most preferred metal oxide is zirconia. The porous matrix can be in the form of beads, rendering this method amenable to packed or fluidized bed chromatography.

Still another embodiment of this invention is a method of preparing the polymer of this invention. The method comprises polymerizing a composition comprising acrylic monomers substituted with quaternary ammonium moieties; hydrophobic acrylic monomers; the linear homopolymer; and acrylic polyfunctional crosslinking monomers. The polymerization reaction is performed in the presence of a polymerization catalyst. Preferably, the composition comprises acrylic spacer monomers.

In a related embodiment, the present invention provides a method of preparing the chromatographic sorbent as described above. A composition comprising acrylic monomers substituted with quaternary ammonium moieties; hydrophobic acrylic monomers; the linear homopolymer; and acrylic polyfunctional crosslinking monomers, is introduced into the pores of a porous matrix as defined above. The composition is then polymerized in the presence of a polymerization catalyst. Finally, the sorbent is washed to remove unreacted material. Preferably, the composition further comprises acrylic spacer monomers. Additionally, the polymer resulting from the polymerization occupies about 50% to about 100% of the pores of the porous matrix.

Still another embodiment of this invention is a chromatography column. The column comprises a tubular member having inlet and outlet ends. Within the tubular member are two stationary porous members, between which is packed the polymer of this invention. Alternatively, the tubular member may be packed with the chromatographic sorbent as described above.

Preferably, the column volume is between about 1 milliliter and about 5000 liters. More preferably, the volume range between about 1 liter and about 100 liters.

In a preferred embodiment, the chromatography column further comprises one or more fluid control devices for flowing a liquid sample upward through the polymer or chromatographic sorbent. Additionally, the column may also comprise a series of stages between the inlet and the outlet ends.

Another embodiment of this invention is a multi-well filter plate. A plurality of volumes of the polymer as described above are dispersed among wells of the filter plate. Preferably, the filter plate has from 2 to 96 wells. Even more preferably, the filter plate has from 24 to 48 wells.

Still a further embodiment of the present invention is a kit comprising either column described above, one or more buffers, and instructions for the using the column. Alternatively, the kit comprises the multi-well plate as defined above, one or more buffers, and instructions for the use of the multi-well plate.

### DETAILED DESCRIPTION OF THE PREFERRED EMBODIMENTS

The inventors have discovered that the “mixed mode” polymer of this invention gives rise to exceptional DNA plasmid separation capability. That is, the presence of hydrophilic moieties in the form of quaternary ammonium groups and pendant amine groups constitutes one mode, while the hydrophobic moeities represent a different mode, each of which contributes to the polymer selectivity toward plasmid DNA.

The mixed mode nature of the present polymer is achieved by copolymerizing a composition comprising, in part, acrylic monomers bearing quaternary ammonium moieties and hydrophobic acrylic monomers. Typical quaternary ammonium moieties are tetra-(lower alkyl)ammonium groups, such as tetramethylammonium, tetraethylammonium, and tetrabutylammonium. The quaternary ammonium moieties may also exist as “mixed” ammonium groups, such as (ethyl)trimethylammonium and (methyl)tributylammonium. The ammonium moieites are charge-balanced by any common anion, such as halide (e.g., F⁻, Cl⁻, Br⁻, I⁻); nitrate; phosphate; and borates such as tetrafluoroborate. Preferred acrylic monomers bearing quaternary ammonium moieties are methacrylamido(lower alkyl)-tri(lower alkyl)ammonium salts. A particularly preferred monomer in this context is methacylamidopropyl-trimethylammonium chloride.

The hydrophobic acrylic monomers typically comprise aliphatic or aromatic moeities, or both. Exemplary aliphatic groups are long chain alkyl groups such as octyl, octadecyl, and undecyl, and lower alkyl groups such methyl, ethyl, tert-butyl, and hexyl. Aromatic groups are C₆-C₁₂ hydrocarbons such as phenyl, biphenyl, and naphthyl. Various combinations of aliphatic and aromatic groups may be employed, for example, benzyl and phenethyl. Exemplary hydrophobic monomers include but are not limited to tert-butyl-acrylamide, n-butyl-acrylamide, n-isopropyl-acrylamide, tert-octyl-acrylamide, methyl-undecyl-acrylamide, octadecyl-acrylamide, phenyl-acrylamide, acrylamido-phenylalanine ethyl ester.

Preferably, the polymer of this invention comprises acrylic spacer monomers, which govern the distance between the acrylic monomers substituted with quaternary ammonium groups and the hydrophobic acrylic monomers. Typically, the spacer monomer is a disubstituted acrylamide, where the substituents are selected from hydrogen and C₁₋₆ lower alkyl groups. The lower alkyl groups may be substituted with one to three hydroxy groups. Thus, preferred spacer monomers include but are not limited to dimethylacrylamide and (trishydroxymethyl)acrylamide.

The polymer of the present invention also comprises a linear homopolymer. The individual monomers of the homopolymer are each substituted with a pendant amine group. The overall effect on the instant polymer is the introduction of a block sequence of amine groups. Secondary and tertiary amines are preferred. Within these general guidelines, the amines should be chosen such that they remain uncharged (i.e., un-protonated) in aqueous media down to a pH of about 4. The homopolymer includes but is not limited to a polymer having a polyacrylamide backbone. Thus, conceivably any monomer bearing polymerizable moieties, such as carbon-carbon and carbon-nitrogen multiple bonds, and a pendant amine moiety, can be employed to generate the linear homopolymer. Illustrative linear homopolymers include poly-dimethylaminopropyl-methacrylamide, poly-diethylaminoethyl-methacrylamide, polyallylamine, polyvinylamine, polyethyleneimine, chitosan, and polylysine. A particularly preferred linear homopolymer is poly-dimethylaminopropyl-methacrylamide. It is preferred but not necessary that the linear homopolymer have a molecular weight between about 5 kilodaltons (kD) and about 5000 kD.

The polymer of this invention further comprises acrylic polyfunctional crosslinking monomers, which serve to create a polymer network when the composition described above is polymerized. The crosslinking monomer must bear at least two acrylamide groups that are utilized in the polymerization process. Typically, the acrylamide groups are separated by a lower-alkylene spacer, such as methylene, ethylene, or propylene. Exemplary crosslinking monomers include but are not limited to N,N′-methylenebisacrylamide and N,N′-methylenebismethacrylamide.

The relative concentrations the linear homopolymer and each monomer that are polymerized to prepare the instant polymer can vary widely. Consequently, the physico-chemical properties of the polymer can be tailored straightforwardly. Generally, the amount of linear homopolymer ranges from about 1 to about 90% (w/w); the amount of acrylic monomers substituted with quaternary ammonium moieties varies between about 0.2 and about 90% (w/w); the amount of hydrophobic acrylic monomers ranges from about 0.2 to about 70%; the amount of acrylic polyfunctional crosslinking monomers varies between about 1 and about 70%; and the amount of acrylic spacer monomers ranges from 0 to about 70%. These weight percentages are based upon the total dry weight of the linear homopolymer and monomers prior to their copolymerization.

Taking the chemical considerations described above into account, the polymer of the invention can be represented structurally by the following formula:

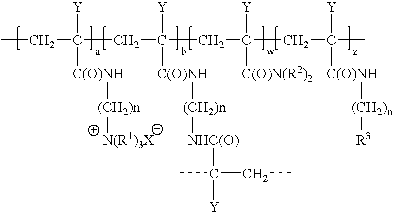

In this general structure, the monomers designated by “a”, “b”, “z”, and “w” can appear in any order and in the preferred relative concentrations described above. It is understood that, in accordance with art-recognized polymer representations, the formula above represents merely an ideal structure. Thus, the structure is meant to encompass polydisperse mixtures of polymers having different molecular weights, degrees of cross-linking, and lengths obtained from methods of making the polymer described below. In this context, it is also understood that the dashed lines (i.e., “-----”) represent the broader macromolecular nature of the cross-linked polymeric structure obtained from random repeating “a”, “b”, “z”, and optionally “w” monomers. As described above in the Summary of the Invention, at least one Y is the linear homopolymer. The inventors discovered that the linear homopolymer, surprisingly, is covalently bound to the overall crosslinked polymer of the invention, rather than existing as a separate component. Additionally, the linear homopolymer serves, at least in part, to tether the crosslinked polymer to the porous matrix, as described below.

While the polymer of this invention may be employed as a sorbent by itself, the surface area of the polymer, and hence its separation capacity, is increased greatly by incorporating it into a porous matrix. Additionally, the mechanical strength of the sorbent is higher than that of the polymer. The porous matrix can be selected from any convenient porous solid material. The most preferred class of such materials is metal oxides, such as silica, alumina, hafnia, titania, and zirconia, which are commercially available. Alternatively, such materials can be made by well-known procedures. For example, a preferred porous matrix is zirconia, which can be prepared by the methods disclosed in U.S. Pat. No. 5,141,634 and No. 5,205,929. Other materials, such as synthetic and natural polymers are also acceptable porous matrices as described in, for example, U.S. Pat. No. 5,593,576, No. 5.599,453, and No. 5,906,734. An advantage of the sorbent is that the porosity and overall shape of individual sorbent particles can be tailored, thereby imparting considerable control over the bulk adsorbent properties of the sorbent. Typically, the sorbent exists in the form of beads between about 10 microns to about 500 microns and of densities ranging from about 1 g/cm³ to about 10 g/cm³.

The polymer of this invention is prepared by straightforward polymerization chemistry. The monomers described above and the linear homopolymer are dissolved in a solvent or a mixture of solvents in the presence of a polymerization catalyst. A preferred solvent is water. The catalyst typically is chosen from classic acrylic polymerization catalysts. Exemplary catalysts in this regard include but are not limited to thermosensitive catalysts such as azobis-amidinopropane and azo-bis-isobutyronitrile. Agents that form radicals are also acceptable as free radical catalysts. These include, for example, mixtures of peroxides, such as ammonium persulfate, hydrogen peroxide, and benzoyl peroxide, and a tertiary amine such as tetramethylethylenediamine. Polymerization may also be initiated by the use of well-known photoinitiators active in the UV region of light.

The chromatographic sorbent of this invention is prepared similarly, except that the composition of monomers, linear homopolymer, and polymerization catalyst must first permeate the pores of the porous matrix. This can be accomplished readily by first drying the porous matrix. If metal oxides are utilized, they should also be passivated prior to use. Second, it is preferred but not necessary to match the composition volume to the overall pore volume of the porous matrix. Finally, the composition is polymerized as described immediately above. The resultant sorbent, after being washed extensively to remove impurities, typically exhibits the crosslinked polymer as a hydrogel, which occupies about 50% to about 100% of the porous matrix pores.

An advantage of the present invention is that the hydrophobic-ionic balance of the polymer may be tailored simply by altering the relative concentrations of hydrophobic acrylic monomers and acrylic monomers substituted with quaternary ammonium moieties. An added degree of control is realized in the concentration of the acrylic spacer monomer; a greater concentration statistically increases the distance between the hydrophobic and quaternary ammonium acrylic monomers. Another advantage is that the requisite block sequence of amines can be achieved through the use of the linear homopolymer as a reactant. Random polymerization of the constituent monomers would not be expected to give this requisite block sequence which, as mentioned above, is necessary for the separation of plasmid DNA.

The present invention also relates to a method for the separation of plasmid DNA. The method is useful in the production of milligram, gram, and even kilogram quantities of pharmaceutical grade plasmid DNA. Generally, the method comprises first loading a cell lysate onto the polymer or chromatographic sorbent of this invention. The cell lysate can originate from bacteria, yeast, fungi, mammalian, or insect cells, for example, as obtained through any conventional method such as shake flask cultures, bioreactors, or fermentors. Preferred hosts are microbial cells, such as E. coli. Preferably, the crude lysate should be clarified to substantially remove plasmid DNA from cell debris and other host contaminants.

The loaded sample thus contains nucleic acids, including plasmid DNA and large quantities of RNA. The sample may also contain chromosomal and genomic DNA. The plasmid DNA of the present invention includes covalently closed circular DNA (i.e., supercoiled monomers), concatenated forms (e.g., supercoiled dimers), and nicked circular forms (i.e., relaxed monomers). In contrast to prior art methods requiring the removal of RNA by adding of RNAse, the present method requires no RNAse.

The polymer or chromatographic sorbent then selectively adsorbs plasmid DNA. Washing with an equilibration buffer removes any unbound material, including RNA. An advantage of the chromatographic sorbent is that it exhibits small pores where nucleic acids cannot diffuse freely. Consequently, the washing step readily removes unbound RNA. To achieve this, the ionic strength of the equilibration buffer should be maintained high enough to prevent a low recovery of plasmid DNA from the polymer or sorbent, yet low enough to allow the plasmid DNA to sufficiently bind to the polymer or sorbent. For example, the equilibration buffer is conveniently maintained at the pH of the crude lysate—typically about pH 5. Additionally, the ionic strength is maintained between about 0.5 and 0.75 mM for sodium chloride.

Plasmid DNA may then be desorbed by applying an aqueous salt solution to the loaded polymer or sorbent. Illustrative salts include but are not limited to sodium chloride and potassium chloride. The concentration of the salt typically is about 1.0 M or less. Plasmid DNA desorption may be enhanced by the additional but optional step of increasing the pH of the salt solution. Following the desorption step, the polymer or sorbent may be regenerated by washing it with 1 M aqueous sodium hydroxide.

As mentioned above, either the polymer or chromatographic sorbent can be used in the separation method. The sorbent, however, is generally more mechanically robust. In a preferred embodiment, for example, the sorbent can be used in packed or fluidized bed chromatography.

The method can also be performed in the context of batchwise separations. For example, the polymer or sorbent may be used as freely dispersed particles in a suspension. Alternatively, the polymer or sorbent can be affixed to surfaces, including the walls of reaction vessels or in the wells of microtiter plates. Small-scale separations can even be performed on appropriately coated pipette tips, agitator rods, or test strips.

Typical purities of plasmid DNA purified by the method of this invention range from about 70% to about 99%, preferably 85% to about 99%, and most preferably about 90% to about 99%.

The separation method described above can be adapted for use in a variety of techniques, including preparative methods employing fixed bed, fluidized bed, and batch chromatographies. Alternatively, the method can be practiced in the context of high throughput separation techniques that utilize small devices such as spin columns or multiwell plate formats where device volumes can be as small as a few microliters.

When using batch adsorption/separation, the polymer or sorbent is added directly to the solution of lysate, and the resultant mixture is gently agitated for a time sufficient to allow the plasmid DNA to bind to the polymer or sorbent. The polymer or sorbent, with adsorbed plasmid DNA, may then be removed by centrifugation or filtration, and the plasmid subsequently eluted from the solid substrate in a separate step as described above.

Alternatively, column chromatography may be used. In fixed bed column chromatography, the polymer or sorbent is packed into a column, and the lysate which contains the plasmid DNA to be separated is applied to the polymer or sorbent by pouring it through the sorbent at a rate that allows the plasmid DNA to bind to the solid substrate.

Advantages of fixed bed chromatography include minimal column volume and water consumption. The disadvantage of the column chromatography method is that the flow rate of liquids through the column is slow, and, therefore, time-consuming. This flow rate can be reduced even further if the material being applied to the column includes particulates, since such particulate material can “clog” the solid substrate to some degree.

In fluidized bed column chromatography, a rising filtration flow and large/dense particles are used in order to maintain an equilibrium against the rising forces. An essentially vertical column composed of between 1 and 5 stages placed on top of the other is used, and the solution successively passes through stage and is drawn off by an overflow on the upper part of the upper stage. Preferably, the column has three stages. Each stage, with the exception of the uppermost one, is separated by two distribution systems, one distributing the solution at the base of the stage in question, the other distributing the solution towards the stage located immediately above.

The advantages of a fluidized bed are higher flow rates at lower pressures as compared to fixed bed chromatography. Although the higher flow rates offer certain advantages to the chromatographic separation, the method has several shortcomings. The method requires either large particle diameter and/or high density resins that expand only under high upward liquid velocity. Large diameter polymer or sorbent particles have less surface area per unit volume than small polymer or sorbent particles used, and correspondingly have less surface binding capacity. This is why small bead polymer or sorbent particles are preferred, in which case the bead polymer or sorbent particles must be highly dense.

On the other hand, fluidized bed chromatography avoids many of the serious disadvantages of fixed beds, which include clogging, need for cleaning, compression and cleaning-induced resin deterioration. In fact, the fluidized bed allows free passage of solid impurities in the solution with no risk of clogging; less stringent cleaning is necessary so the life-span of the polymer or sorbent particles is greatly increased. However, the chromatographic sorbents for biological substances typically are not suitable for fluidized bed chromatography, having a density too close to that of water or being too small in granulometry. This makes it impossible to fluidize without drawing particles into the flux. Another problem with fluidized bed chromatography of biological substances generally relates to the large space between beads, which would result in a decrease in efficiency.

In view of these factors, batch and fixed bed chromatography have been the methods of choice in prior art separation techniques for plasmid DNA. The present polymer or sorbent, on the other hand, can be used in batch, fixed bed, or fluidized bed chromatography.

Thus, in a preferred embodiment, the present invention provides a chromatography column, which is a tubular member packed with the solid substrate described herein. The tubular member can be made of any suitable material, such as glass, plastic, or metal. The packed solid substrate is abutted on each end by porous members that keep the substrate fixed within the tubular member.

In some embodiments, gravity flow of an eluant through a column is sufficient. In other embodiments, the column may comprise one or more fluid moving devices to achieve an upward flow of eluant through the column. Such devices include pumps, injectors, and any other device typically employed in association with chromatography equipment.

The chromatography column of this invention can be of any volume. For example, separations on a laboratory scale may warrant a column volume as small as about 1 mL. Large scale purification and isolation of biological substances can be performed on columns as large as 5000 liters. More typical volumes are between 1 liter and 100 liters. The column is tubular in general shape, but is not otherwise particularly limited in length or diameter. Depending upon the context in which the column is employed, the column diameter can vary between about 0.5 mm to about 1000 mm. Additionally, the column length can vary between about 50 mm to about 1000 mm. Thus, the invention contemplates columns of a variety of dimensions and corresponding volumes.

Successive fractions may be collected from the column and analyzed by standard gel electrophoresis techniques to identify the different forms of plasmid DNA that elute. Under the general conditions prescribed above, dimer and nicked forms of plasmid DNA typically elute before supercoiled DNA. Genomic DNA, however, is found essentially in the fraction obtained after regeneration with sodium hydroxide as described above.

The column of this invention can be used in tandem with columns comprising other solid substrates, which would be effective in eliminating different impurities from a sample. Thus, the advantages of the present column can be viewed as being complementary to the characteristics of other or conventional columns. In this context, such a tandem arrangement of columns would conserve eluants and equilibration buffer, thereby eliminating the need for additional sample manipulation and preparation.

The present invention also contemplates a multi-well filter plate. The wells typically are arranged in a format suitable for screening purposes. A preferred format is a regular pattern such as an “X-Y” matrix. Each well contains a volume of the polymer or chromatographic sorbent of this invention. Using the general separation methodology described above, the wells yield supernatant solutions containing DNA fractions, which can be transferred to a second multi-well filter plate. The individual volumes of DNA are precipitated by the addition of a suitable solvent such as ethanol or isopropanol. The DNA precipitates are redissolved in small volumes of a low salt buffer, collected in a third multi-well plate, and finally subjected to electrophoresis gel chromatography. The multi-well plate of this invention thus makes it possible to investigate the properties of different polymers or sorbents using the same equilibration buffer or the properties of one polymer or sorbent using different equilibration buffers. Additionally, the multi-well plate allows the screening of multiple lysates obtained from different hosts for plasmid DNA fractions. Alternatively, it may be desirable to introduce a different polymer or sorbent into each well in order to identify the polymer or sorbent most efficient in separating plasmid DNA obtained from a particular lysate. The compatible formats of the multi-well plate with standard electrophoresis chromatography thus allows high throughput screening.

The multi-well plates are well-known laboratory equipment. Typically, the number of wells ranges from 2 to 96. Preferably, the number of wells is from about 24 to 48.

The kits of the present invention incorporate the chromatography column or multi-well filter plate as described above. The kits further provide the buffers or eluants necessary to achieve plasmid separation, together with instructions sufficient to guide an end user on the use of the column or multi-well plate.

The following examples are given to illustrate the present invention. It should be understood, however, that the invention is not to be limited to the specific conditions or details described in these examples.

### EXAMPLE 1

### Preparation of Chromatographic Sorbent in Zirconia Beads

The purpose of this example is to demonstrate the preparation of a mixed-mode polymer dispersed within the pores of zirconia beads.

A. Preparation of Linear Homopolymer

30 mL of pure dimethyl-aminopropyl-methacrylamide were mixed with 70 mL of distilled water. The resultant mixture was treated with a catalyst prepared by mixing together 0.5 g of ammonium persulfate and 1 mL of tetramethyl-ethylenediamine. The mixture was left at room temperature for 5 hours. The resulting linear polymer was evidenced by an increase of the viscosity of the solution.

The linear homopolymer was isolated by precipitation with acetone followed by several washings to remove non polymerized material, excess catalyst, and by-products. Finally the linear polymer was dried under vacuum.

B. Preparation of Sorbent

In 10 ml of water following products were dissolved: 0.3 g of linear polymer prepared as above in (A), 0.1 g of tert-butyl-acrylamide, 0.9 g of dimethylacrylamide, 0.8 g of methacrylamidopropyl-trimethylammonium chloride and 0.1 g of N,N′-methylene-bis-methacrylamide. The resulting alkaline solution (pH 12) was added at room temperature of 50 mg of azobis-amidinopropane as a polymerization catalyst. This mixture was subsequently added to dry and passivated porous zirconia beads. The amount of beads was calculated so that the volume of the solution was equivalent to the pore volume of zirconium oxide.

The mixture of zirconia beads and polymerization solution as shaken for about 10 minutes in order to allow the entire solution to adsorb inside the pores of the zirconia beads. Then the mixture was homogeneously heated up to 85° C. under a nitrogen atmosphere. Under these conditions, the polymerization intiated within the pore volume of the porous zirconia beads. The resultant polymer formed appeared as a hydrogel trapped inside the beads, but was visible on the external surface of the beads as a thin layer.

The resulting sorbent was washed extensively with alkaline and acidic solutions until all excess reagents and by-products were eliminated.

As noted, the sorbent is designated as “mixed-mode” because it contains, on the same polymer backbone, blocks of hydrophilic moieties in the form of pendant amines (from the linear polymer) and quaternary ammonium moieties together with hydrophobic (t-butyl) groups. The hydrophilic character of the polymer is quantitated by washing the polymer with 1.0 M NaOH, titrating with 10 mM HCl, and generating standard pH curves and the resulting pK value(s) for the polymer. The hydrophobic character of the polymer is quantitated by measuring the retention time of butyl-para-hydroxybenzoate (BPHB) that is injected onto a column of the chromatographic sorbent previously washed with the equilibration buffer as described above. The BPHB is eluted by an aqueous mobile phase of 0.1 M NaOAc, 0.07 M NaCl at pH 5. Thus, a typical measurement in this context entails the injection of 50 μL of a 0.1 mg/mL solution of BPHB at a rate of 1 mL/min using a HPLC system. The eluted BPHB was detected by UV absorbance at 254 nm. The resulting retention factor, K′, is calculated by performing a control experiment using the same mobile phase on naked zirconia. Thus retention factors—a measure of the polymer's hydrophobic mode—can be used to compare various sorbent/mobile phase combinations.

### EXAMPLE 2

### Separation of Plasmid DNA

The purpose of this example is to demonstrate the separation of plasmid DNA on the sorbent prepared in Example 1.

The sorbent prepared according to Example 1 was packed into a chromatography column and then equilibrated with a buffer containing 50 mM acetate and 0.65 mM sodium chloride at pH 5.

The column was loaded with a clarified lysate of E. coi from which proteins and other impurities were previously eliminated according to standard procedures well known in the art. No RNAse was added to the lysate.

The column was then washed with volumes of the buffer sufficient to remove non-plasmid DNA material. An aqueous sodium chloride gradient up to 1 M was applied to the column in order to desorb and elute the plasmid DNA fractions. At the end of the gradient, a 1 M aqueous sodium hydroxide solution was passed through the column to regenerate the sorbent.

The eluant fractions were collected and analyzed by agarose gel electrophoresis according to well-established protocols. The fractions indicated that all of the RNA was contained in the initial buffer wash. Under the sodium chloride gradient, dimer and nicked plasmid DNA fragments eluted before the supercoiled plasmid DNA. Genomic DNA eluted with the sodium hydroxide regeneration wash.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A polymer comprised of:
(a) a crosslinked copolymer comprising
(i) acrylic monomers substituted with quaternary ammonium moieties and
(ii) hydrophobic acrylic monomers;
(iii) acrylic polyfunctional crosslinking monomers
(b) a linear homopolymer comprised of monomers, each of them substituted with pendant amine groups,
wherein the crosslinked copolymer is covalently bonded to the linear homopolymer.

2. The polymer according to claim 1, wherein the crosslinked copolymer further comprises acrylic spacer monomers.

3. The polymer according to claim 1, wherein the pendant amine groups of the linear homopolymer are secondary or tertiary amines.

4. The polymer according to claim 3, wherein the linear homopolymer is selected from the group consisting of poly-dimethylaminopropyl-methacrylamide, poly-diethylaminoethyl-methacrylamide, polyallylamine, polyvinylamine, polyethyleneimine, chitosan, and polylysine.

5. The polymer according to claim 1, wherein the hydrophobic monomers are selected from monomers comprised of one or both of aliphatic and aromatic groups.

6. The polymer according to claim 5, wherein the hydrophobic monomers are selected from the group consisting of tert-butyl-acrylamide, n-butyl-acrylamide, n-isopropyl-acrylamide, tert-octyl-acrylamide, methyl-undecyl-acrylamide, octadecyl-acrylamide, phenyl-acrylamide, acrylamido-phenylalanine ethyl ester, and mixtures thereof.

7. The polymer according to claim 1, wherein polymer is represented by the formula: 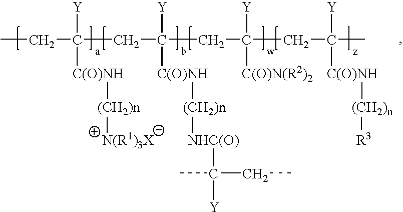
wherein
R¹ is C₁₋₆ alkyl;
each R² is independently selected from the group consisting of H and C₁₋₆ alkyl optionally substituted with 1 to 3 OH groups;
R³ is selected from H, C₁₋₁₄ alkyl, and (C₁₋₁₄ alkyl)aryl;
each n is independently an integer from 1 to 6;
a is at least 1;
b is at least 1;
w is an integer from 0 to 10;
z is at least 1; and
X is an anion;
each Y is independently selected from the group consisting of H, C₁₋₆ alkyl, and the linear homopolymer, provided that at least one Y is the linear homopolymer; and
----- represents the remainder of the polymer.

8. A chromatographic sorbent comprising:
(a) a polymer comprised of:
(i) a crosslinked copolymer comprising
(A) acrylic monomers substituted with quaternary ammonium moieties and
(B) hydrophobic acrylic monomers;
(C) acrylic polyfunctional crosslinking monomers; and
(ii) a linear homopolymer comprised of monomers, each of them substituted with pendant amine groups,
wherein the crosslinked copolymer is covalently bonded to the linear homopolymer; and
(b) a porous matrix,
wherein the polymer is dispersed within the pores of the porous matrix.

9. The sorbent according to claim 8 wherein the porous matrix is one selected from the group consisting of metal oxides, ceramics, natural polymers, synthetic polymers, and mixtures thereof.

10. The sorbent according to claim 9, wherein the porous matrix is a metal oxide.

11. The sorbent according to claim 10, wherein the metal oxide is one selected from the group consisting of silica, alumina, hafnia, titania, and zirconia.

12. The sorbent according to claim 9, wherein the porous matrix is a natural polymer.

13. The sorbent according to claim 12, wherein the natural polymer is a polysaccharide selected from the group consisting of agarose, dextran, cellulose, chitin and derivatives thereof, and alginic acid.

14. The sorbent according to claim 9, wherein the porous matrix is a synthetic polymer.

15. The sorbent according to claim 14, wherein the synthetic polymer is one selected from the group consisting of polyacrylamides, polyacrylates, polyvinyl polymers, polystyrenes, polyurethanes, polyamides, and polyfluorinated derivatives and copolymers thereof.

16. The sorbent according to claim 8, wherein the porous matrix is in the form of beads.

17. The sorbent according to claim 16, wherein the beads have a diameter between about 10 microns and about 500 microns.

18. The sorbent according to claim 16, wherein the beads have a density between about 1 g/cm³ and about 10 g/cm³.

19. A method for the separation of DNA plasmids comprising
(a) loading a lysate comprising DNA plasmids onto a polymer comprised of:
(i) a crosslinked copolymer comprising
(A) acrylic monomers substituted with quaternary ammonium moieties and
(B) hydrophobic acrylic monomers;
(C) acrylic polyfunctional crosslinking monomers; and
(ii) a linear homopolymer comprised of monomers, each of them substituted with pendant amine groups,
wherein the crosslinked copolymer is covalently bonded to the linear homopolymer,
whereby the plasmids adsorb to the polymer;
(b) washing the polymer bound with adsorbed plasmids with an equilibration buffer, thereby removing non-plasmid material; and
(c) applying an eluant comprising a salt solution to the polymer bound with adsorbed plasmids, whereby the plasmids desorb from the polymer.

20. The method according to claim 19, wherein the lysate is a clarified lysate.

21. The method according to claim 19, wherein the separation is performed in a chromatography column.

22. The method according to claim 19, wherein the separation is performed batch-wise on the polymer either in a suspension or fixed on reaction vessels, microtiter plates, pipette tips, agitator rods, or test strips.

23. The method according to claim 19, wherein the lysate comprises plasmids existing in at least two different forms.

24. The method according to claim 23, further comprised of separating the different forms of plasmids.

25. A method for the separation of DNA plasmids comprising
(a) loading a lysate comprising DNA plasmids onto a chromatographic sorbent comprised of:
(i) a polymer comprised of:
(A) a crosslinked copolymer comprising
(1) acrylic monomers substituted with quaternary ammonium moieties and
(2) hydrophobic acrylic monomers;
(3) acrylic polyfunctional crosslinking monomers; and
(B) a linear homopolymer comprised of monomers, each of them substituted with pendant amine groups,
wherein the crosslinked copolymer is covalently bonded to the linear homopolymer; and
(ii) a porous matrix,
wherein the polymer is dispersed within the pores of the porous matrix,
whereby the plasmids adsorb to the sorbent;
(b) washing the sorbent bound with adsorbed plasmids with an equilibration buffer, thereby removing non-plasmid material; and
(c) applying an eluant comprising a salt solution to the sorbent bound with adsorbed plasmids, whereby the plasmids desorb from the sorbent.

26. The method according to claim 25, wherein the porous matrix is a metal oxide.

27. The method according to claim 26, wherein the metal oxide is zirconia.

28. The method according to claim 25, wherein the porous matrix is in the form of beads.

29. The method according to claim 25, wherein the separation is performed in a packed bed or fluidized bed.

30. A method for the preparation of the polymer according to claim 1, comprising polymerizing a composition comprised of the (a) acrylic monomers substituted with quaternary ammonium moieties; (b) hydrophobic acrylic monomers; (c) linear homopolymer; and (d) acrylic polyfunctional crosslinking monomers in the presence of a polymerization catalyst.

31. The method according to claim 30, wherein the composition further comprises acrylic spacer monomers.

32. A method for the preparation of the sorbent according to claim 8, comprising:
(a) introducing into the pores of the porous matrix a composition comprised of the (i) acrylic monomers substituted with quaternary ammonium moieties; (ii) hydrophobic acrylic monomers; (iii) acrylic polyfunctional crosslinking monomers, and (iv) linear homopolymer;
(b) polymerizing the composition in the presence of a polymerization catalyst; and
(c) washing the sorbent.

33. The method according to claim 32, wherein the composition further comprises acrylic spacer monomers.

34. The method according to claim 32, wherein the polymer occupies about 50% to about 100% of the pores of the porous matrix.

35. A chromatography column, comprising:
(a) a tubular member having an inlet end and an outlet end;
(b) first and second stationary porous members disposed within the tubular member; and
(c) the polymer according to claim 1 packed within the tubular member between the first and second porous members.

36. The chromatography column according to claim 35, wherein the column volume is between about 1 milliliter and about 5000 liters.

37. The chromatography column according to claim 36, wherein the column volume is between about 1 liter and about 100 liters

38. The chromatography column according to claim 35, further comprising one or more fluid control devices for flowing a liquid sample through the polymer.

39. The chromatography column according to claim 35, comprising a series of stages between the inlet end the said outlet end.

40. A chromatography column, comprising:
(a) a tubular member having an inlet end and an outlet end;
(b) first and second stationary porous members disposed within the tubular member; and
(c) the sorbent according to claim 11 packed within the tubular member between said first and second porous members.

41. The chromatography column according to claim 40, wherein the column volume is between about 1 milliliter and about 5000 liters.

42. The chromatography column according to claim 41, wherein the column volume is between about 1 liter and about 100 liters

43. A chromatography column according to claim 40, further comprising one or more fluid control devices for flowing a liquid sample upward through the sorbent.

44. A chromatography column according to claim 40, comprising a series of stages between the inlet end and the outlet end.

45. A multi-well filter plate comprising a plurality of volumes of the polymer according to claim 1 dispersed among the wells of the filter plate.

46. The filter plate according to claim 45, wherein the filter plate has from 2 to 96 wells.

47. The filter plate according to claim 46, wherein the filter plate has from 24 to 48 wells.

48. A kit comprising the column according to claim 35, one or more buffers, and instructions for chromatographic use thereof.

49. A kit comprising the column according to claim 40, one or more buffers, and instructions for chromatographic use thereof.

50. A kit comprising the multi-well plate according to claim 45, one or more buffers, and instructions for chromatographic use use thereof.
